(19) United States
(12) Patent Application Publication
(10) Pub. No.: US 2024/0162936 A1
(43) Pub. Date: May 16, 2024

(54) METHOD AND APPARATUS FOR COMMUNICATION VIA INDUCTIVE COUPLING

(71) Applicants: Arm Limited, Cambridge (GB); ECS Partners Limited, Southampton (GB)

(72) Inventors: Benjamin James Fletcher, Burwell (GB); James Edward Myers, Bottisham (GB); Shidhartha Das, Upper Cambourne (GB); Sahan Sajeewa Hiniduma Udugama Gamage, Cambridge (GB)

(73) Assignees: Arm Limited, Cambridge (GB); ECS Partners Limited, Southampton (GB)

(21) Appl. No.: 18/282,899

(22) PCT Filed: Feb. 28, 2022
(86) PCT No.: PCT/GB2022/050532

§ 371 Date: Sep. 19, 2023

(30) Foreign Application Priority Data
Mar. 24, 2021 (GB) 2104174.4

(51) Int. Cl. H04B 5/24; H04L 5/00

(52) U.S. Cl. CPC H04B 5/24; H04L 5/0007

(57) ABSTRACT

The present disclosure provides a method and apparatus for communicating between dice of an inductively-coupled 3D integrated circuit (3D-IC). A transmit resonant circuit at a transmit die is inductively coupled to a first receive resonant circuit at a first receive die, and to a second receive resonant circuit at a second receive die. The resonant circuit at the targeted receive die is tuned to the frequency of resonance of the transmit resonant circuit, while the resonant circuit at the untargeted receive die is detuned, resulting in lower power consumption for a given bit error rate at the targeted die.

### BACKGROUND

The present disclosure relates to three-dimensional (3D) integration of electronic circuits. More particularly, the present disclosure relates to wireless, or contactless, 3D integration.

3D integration is gaining traction as a technique to increase device density within integrated circuits by extending them vertically: A number of integrated circuit dice are vertically stacked, forming a three-dimensional structure. The integrated circuit dice may comprise, for example, memory (e.g., RAM, ROM, volatile and non-volatile), processor cores, digital logic structures, physical intellectual property (e.g., hardware accelerators, foundry- and process-optimized circuit designs), security (e.g., encryption) engines, analog and radio-frequency circuits, etc., and may be implemented in silicon or other semiconductors (e.g., gallium arsenide (GaAs)).

A fundamental concern in 3D integration is the method of interconnecting the stacked dice, i.e., communicating vertically between the dice. Presently, most 3D integration implementations assume the use of through-silicon vias (TSVs) to interconnect the vertically stacked layers. However, TSVs require post-fabrication processing and/or strict die-to-die stacking alignments, each of which increase production costs of the 3D integrated circuit.

An alternative to TSVs is wireless, or contactless, 3D integration. In this technology, multiple stacked dice can communicate data wirelessly between them through near-field, inductive or capacitive coupling. Frequently, inductively-coupled 3D integration is favored over capacitively-coupled 3D integration, due to the increased communication distances that can be achieved. Generally, the wireless 3D integration technology used must accommodate the data or traffic (e.g., clocks) communicated between the stacked dice while satisfying various design constraints, such as power, performance and area (PPA), bit error rates, data rates (throughput), manufacturing cost, etc., that may conflict with one another.

In inductively-coupled 3D integration, inductors are placed on stacked dice in a physical arrangement that promotes inductive coupling. The vertical communication occurs as follows: Data is encoded in a series of current pulses which are fed through a planar inductor fabricated in the upper back-end-of-line (BEOL) interconnect layers of the transmitting die. These current pulses generate a magnetic field which is intersected by similar receiving inductors, fabricated in neighboring dice. This induces a current in the receiving inductors which can be detected and hence the data stream, or clock signal, can be recovered.

However, it is frequently desired for, e.g., reduced cost, to place additional (i.e., more than two) dice in a stack. If additional dice are stacked, having additional receiving inductors, the current in the transmitting inductor will also induce current in the additional inductors, even though the additional dice may not be the targeted recipients of the communication. This has the undesired result of reducing the current coupled into the inductor of the targeted communication recipient, which may result in a reduction of the attainable data rate, an increase in power required for a given bit error rate of the targeted communication link, a lower upper bound on the number of dice that may be stacked, or other unwanted behaviors.

### BRIEF DESCRIPTION OF THE DRAWINGS

FIG. 1 depicts a stacked 3D-integrated circuit (3D-IC) using inductively coupled wireless interconnect between dice.

FIG. 2 depicts a multi-tier 3D-IC in which the inductive coupling link spans across several layers.

FIG. 3 depicts a schematic illustration of an inductive coupling link with variable tuning capacitors to adjust the frequency of resonance of each transceiver, in accordance with an embodiment of the present disclosure.

FIG. 4 depicts a resonant circuit, in accordance with an embodiment of the present disclosure.

FIG. 5 depicts simulation results showing the effects of tuning in a four-layer inductive channel, formed using 50 nH planar square spiral inductors, in accordance with an embodiment of the present disclosure.

FIG. 6 depicts a communication protocol, in accordance with an embodiment of the present disclosure.

FIG. 7 depicts a round-robin communication protocol, in accordance with an embodiment of the present disclosure.

FIG. 8 depicts a flow chart, in accordance with an embodiment of the present disclosure.

FIG. 9 depicts a flow chart, in accordance with an embodiment of the present disclosure.

### DETAILED DESCRIPTION

Embodiments of the present disclosure will now be described with reference to the drawing figures, in which like reference numerals refer to like parts throughout.

Embodiments of the present disclosure advantageously provide a method and apparatus for communicating between dice of an inductively-coupled 3D integrated circuit (3D-IC). More particularly, embodiments of the present disclosure advantageously reduce the transmit power required to achieve a given Bit Error Rate (BER) on a given communication link between dice of a 3D-IC, reduce the BER for a given transmit power, or enable communication at a given BER between a greater number of dice in a 3D-IC for the same power requirement, all in a cost-effective manner, in that wireless stacked 3D-ICs can be assembled without the post-fabrication processing or strict die-to-die stacking alignments required by TSVs.

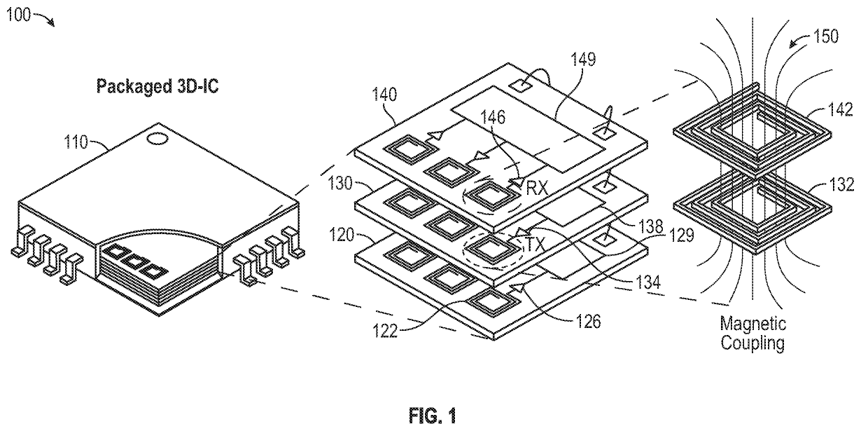

FIG. 1 depicts a stacked 3D-integrated circuit (3D-IC) using inductively coupled wireless interconnect between three dice. In 3D-IC 100, packaged 3D-IC 110 is comprised of three dice—a die that is not the target receiver of an upcoming message, nontarget die 120; a die that is to transmit an upcoming message, transmit die 130; and a die that is the target receiver of the upcoming message, target die 140. Nontarget die 120 comprises inductor 122 coupled to receiver 126; receiver 126 is coupled to data sink 129. Transmit die 130 comprises inductor 132 coupled to transmitter 134; transmitter 134 is coupled to data source 138. Target die 140 comprises inductor 142 coupled to receiver 146; receiver 146 is coupled to data sink 149. Inductor 122, inductor 132, and inductor 142 are coupled via magnetic field 150. Data from data source 138 to be transmitted is sent to transmitter 134, where it is encoded in a series of current pulses fed through inductor 132. These current pulses in inductor 132 form magnetic field 150, which is intersected by inductor 142, generating a current which is detected at receiver 146, where the encoded data is recovered and sent to data sink 149.

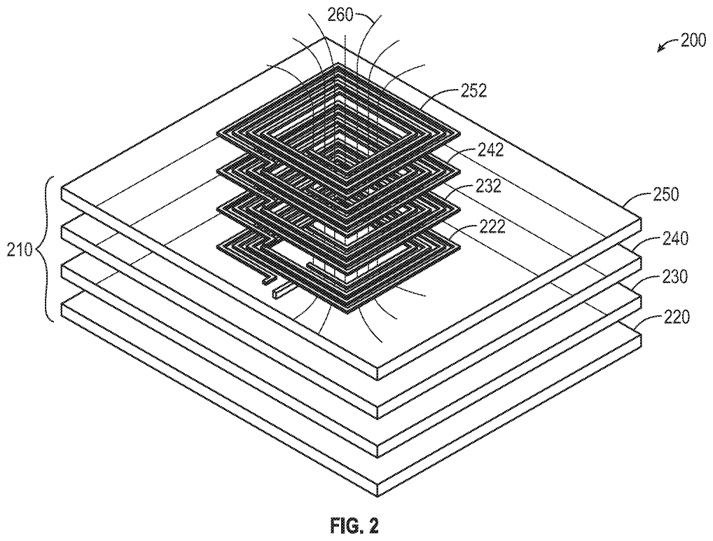

However, magnetic field 150 also is intersected by inductor 122, inducing a current in inductor 122 that reduces the magnetic flux linkage between inductor 132 and inductor 142 on target die 140, reducing the current to be detected at receiver 146. This problem is only made worse as more dice are stacked in wireless stacked 3D-ICs, since more nontarget dice may be present. For example, as depicted in FIG. 2, a wireless stacked 3D-IC 200 having a die stack 210, including dice 220, 230, 240 and 250 comprising inductors 222, 232, 242 and 252, respectively, requires that a transmitting inductor generate a magnetic field 260 that must span all four dice; of these four dice, two may be nontarget dice.

For clarity of exposition, in the following a single die, “transmit die 305,” “die 0” or the like, frequently will be described as the “transmit die,” and the remaining dice in the 3D-IC described as “receiving dice.” However, it should be understood that, in accordance with an embodiment of the present disclosure any die in the 3D-IC may transmit, and any die may receive. Further, while some embodiments of the present disclosure may feature at least one die having a separate transmitter and receiver, other embodiments may feature at least one die in which a transmitter and receiver comprise a transceiver, while remaining in the scope of the present disclosure.

FIG. 3 depicts a schematic illustration of an inductively-coupled 3D-IC 300, in accordance with an embodiment of the present disclosure. At transmit die 305, data source 350 is coupled to transmitter 302 by data link 352. Transmitter 302 is coupled to transmit resonant circuit 304 by transmit links 354(a) and 354(b) and by transmit state control link 306. At first die 315, first data sink 360 is coupled to first receiver 312 by first data link 362. First receiver 312 is coupled to first resonant circuit 314 by first receive links 364(a) and 364(b) and by first state control link 316. At second die 325, second data sink 370 is coupled to second receiver 322 by second data link 372. Second receiver 322 is coupled to second resonant circuit 324 by second receive links 374(a) and 374(b) and by second state control link 326. At third die 335, third data sink 380 is coupled to third receiver 332 by third data link 382. Third receiver 332 is coupled to third resonant circuit 334 by third receive links 384(a) and 384(b) and by third state control link 336. Transmit resonant circuit 304, first resonant circuit 314, second resonant circuit 324 and third resonant circuit 334 are inductively coupled by magnetic field 340.

Transmit link 354(b) and receive links 364(b), 374(b) and 384(b) may be independent return links, differential return links or may be a power supply rail, e.g., ground, Vss, Vcc or Vdd.

Transmit resonant circuit 304 has a frequency of resonance, i.e., a frequency at which the amplitude of magnetic field 340, generated by transmit resonant circuit 304 in response to an input of given amplitude at transmit links 354(a) and 354(b), is at maximum. First resonant circuit 314, second resonant circuit 324 and third resonant circuit 334 also have frequencies of resonance, i.e., frequencies at which outputs at receive links 364(a) and 364(b), 374(a) and 374(b) and 384(a) and 384(b), respectively, are at maximum for a given amplitude of magnetic field 340. Depending upon the type of signal present at transmit link 354 and receive links 364, 374 and 384, the relevant frequency may be a frequency of antiresonance; in this disclosure, for clarity of exposition the term “frequency of resonance” shall be interpreted to include “frequency of antiresonance.” In response to a control signal sent by receivers 312, 322 and 323 via state control links 316, 326 and 336, resonant circuits 314, 324 and 334 independently may be placed in a tuned state, in which their frequencies of resonance are that of transmit resonant circuit 304, or in a detuned state, in which their frequencies of resonance differ from that of transmit resonant circuit 304 by a frequency offset.

Data from data source 350 to be transmitted is sent via data link 352 to transmitter 302. Transmitter 302 encodes the data to be transmitted into a series of current pulses fed through transmit resonant circuit 304 via transmit link 354(a), and returned via transmit link 354(b). These current pulses in transmit resonant circuit 304 form magnetic field 340, which is intersected by resonant circuits 314, 324 and 334, generating a signal sent via receive links 364(a) and 364(b), 374(a) and 374(b) and 384(a) and 384(b) to receivers 312, 322 and 332, respectively, where the encoded data is recovered. The recovered data is sent to the appropriate data sink (data sink 370, 370 or 380), i.e., the data sink to which it was addressed, via data link 362, 372 or 382, respectively.

The series of current pulses encoded by Transmitter 302 has spectral components that comport with the frequency of resonance of transmit resonant circuit 304. In accordance with an embodiment of the present disclosure, transmitter 302 transmits a signal having a carrier frequency that comports with the frequency of resonance of transmit resonant circuit 304, on which data to be transmitted is encoded by phase-shift keying modulation. In particular, due to its communication qualities and low cost, binary phase-shift keying modulation is useful. Other types of modulation, including, e.g., on-off keying (OOK), pulse-position modulation (PPM), and combinations thereof also are useful. Receivers 312, 322 and 332 are operable to receive and demodulate the signal transmitted by transmitter 302.

If the target recipient of an upcoming message is known in advance of the communication (for example if the packet is being sent during a prearranged time-slot, or has been agreed through a broadcast message on the inductive coupling bus), the receiver(s) not involved in the communication may use their state control link to place their resonant circuit(s) in a detuned state, separated from the frequency of resonance of transmit resonant circuit 304 by a frequency offset, while the receiver(s) targeted for the upcoming message may use their state control link to place their resonant circuit(s) in a tuned state, at the frequency of resonance of transmit resonant circuit 304, thereby maximizing the flux linkage between the transmitter and the target receiver(s).

Transmit resonant circuit 304 and resonant circuits 314, 324 and 334 may comprise, e.g., one or more inductive elements and one or more capacitive elements, and may have elements arranged in series, parallel, or a combination of such topologies. A parallel topology of inductive and capacitive elements is useful, in that at the frequency of resonance a voltage maximum is produced across the elements, simplifying detection in some receiver architectures. The capacitive element may comprise one or more of a fixed capacitor, a varactor, and switchable capacitive elements; the varactor and the switchable capacitive elements, under control of the relevant receiver (e.g., third receiver 332 via third state-control coupling 336 for third resonant circuit 334), must have sufficient adjustment range to place the resonant circuit in either the tuned state or the detuned state, as required.

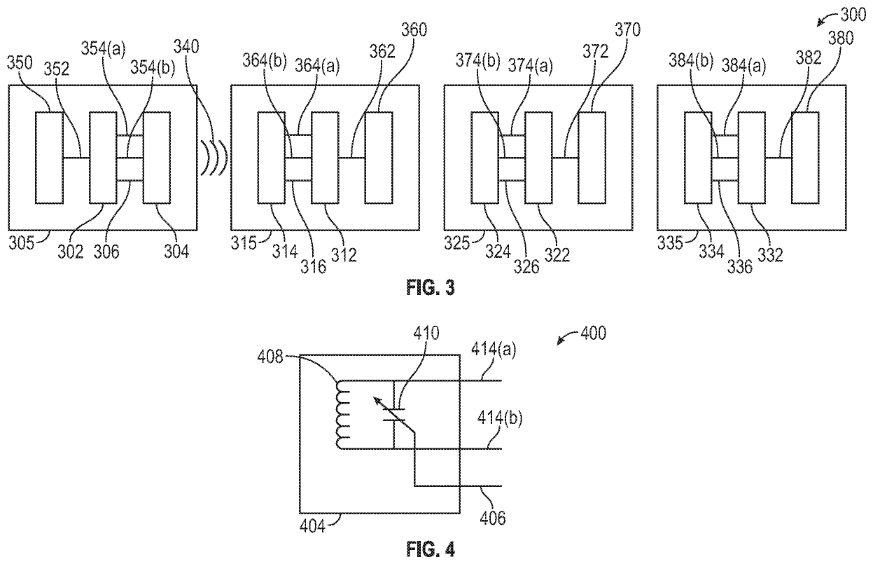

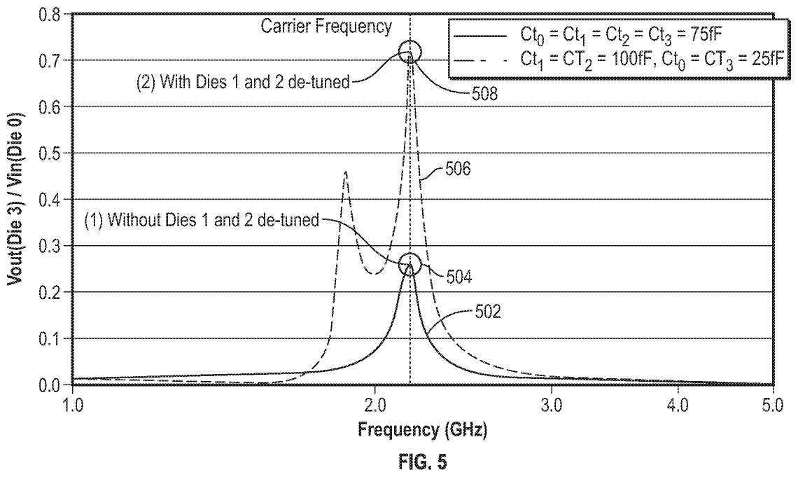

FIG. 4 depicts a schematic illustration of a circuit 400 in accordance with an embodiment of the present disclosure. Resonant circuit 404, which can be useful as transmit resonant circuit 304 and resonant circuit 314, 324 and 334, comprises inductive element 408, which may be an inductor and is coupled in parallel with adjustable capacitive element 410; link 414(a) is coupled to one node of the parallel circuit and link 414(b) is coupled to the other node. The state of resonant circuit 404 is controlled by state control 406, which adjusts the capacitance of adjustable capacitive element 410. For example, adjustable capacitive element 410 may be an array of switchable capacitors; when used in resonant circuit 314, 324 or 334, the signal on state control 406 selects appropriate elements of the array to produce the capacitance necessary to place resonant circuit 404 in the desired state (i.e., tuned or detuned).

FIG. 5 depicts results of an AC (alternating-current) simulation, in accordance with an embodiment of the present disclosure. In this simulation, four instantiations of resonant circuit 404, simulating transmit resonant circuit 304 of transmit die 305 (die 0) and receive resonant circuits 314, 324 and 334 of first receive die 315 (die 1), second receive die 325 (die 2) and third receive die 335 (die 3), respectively, were employed to simulate the effects of tuning in a four-dice inductive coupling channel. FIG. 5 plots the ratio of Vout (measured between receive links 384(a) and 384(b) at third die 335 (die 3)) to Vin (measured between transmit links 354(a) and 354(b) at transmit die 305 (die 0)), as a representation of communication efficiency.

The inductive element of each instantiation (e.g., inductive element 408 of resonant circuit 404) was formed using a 50 nH planar square spiral inductor. The capacitive element of each instantiation (e.g., capacitive element 410) was varied, to consider two cases:

In Case (1), all resonant circuits are in the tuned state, i.e., each of the tuning capacitors within the stack has the same value, 75 fF, and so the best channel efficiency is measured between die 0 and die 1, since they are physically closest (achieving an efficiency of 0.67, not shown in FIG. 5). The communication efficiency between die 0 and die 3, represented by solid curve 502 of FIG. 5, is measured to be significantly lower, reaching 0.27 (peak 504 of FIG. 5).

In Case (2), to maximize communication efficiency between die 0 and die 3, the resonant circuit of die 3 (receive resonant circuit 334) remains in the tuned state, but the resonant circuits of dice 1 and 2 (receive resonant circuits 314 and 324, respectively) are placed in the detuned state. To achieve the largest frequency offset, the value of the capacitive element of transmit resonant circuit 304 (e.g., capacitive element 410) of die 0 is decreased, to 25 fF; because the resonant circuit of die 3 (receive resonant circuit 334) is in the tuned state, the value of its capacitive element is also decreased to 25 fF. Because the resonant circuits of dice 1 and 2 are in the detuned state, the value of the capacitive elements of receive resonant circuits 314 and 324 (e.g., capacitive element 410) of dice 1 and 2 is increased, to 100 fF. With these state changes in place, the communication efficiency between Die 0 and Die 3, as represented by dashed curve 506 of FIG. 5, is boosted to 0.71 (peak 508 of FIG. 5), representing a 2.6× improvement in Vout/Vin over Case (1).

In accordance with an embodiment of the present disclosure, the amount of frequency offset may be static, having a fixed, nominal value. In accordance with another embodiment of the present disclosure, the amount of frequency offset may be dynamic, responsive to a determination of a wireless bus master or controller of communication channel quality. Such a determination of communication channel quality may be based on, for example, a bit error rate measurement, a symbol error rate measurement, a word error rate measurement, or a message error rate measurement, or may be a signal-to-noise ratio measurement.

Should the bus master determine that the quality of the communication channel between a transmit die and a target die has fallen below a threshold, for example, the bus master may instruct one or more non-target dice (i.e., dice in a detuned state) to increase their frequency offsets, thereby reducing signal loss in the wireless buss between the transmitting die and the target die and, therefore, improving the channel quality between them.

It was noted supra that the target recipient of an upcoming message must be known in advance of the communication, in order for the states of the receiving resonant circuits to be as disclosed herein. In accordance with an embodiment of the present disclosure, this knowledge may be transmitted from transmitting die 305 (die 0) via a broadcast message sent prior to the upcoming message. If necessary, the broadcast message may be sent at a lower data rate and/or a higher transmit power to ensure reception since, as a broadcast message, the receive resonant circuits of all receiving dice will have a tuned state.

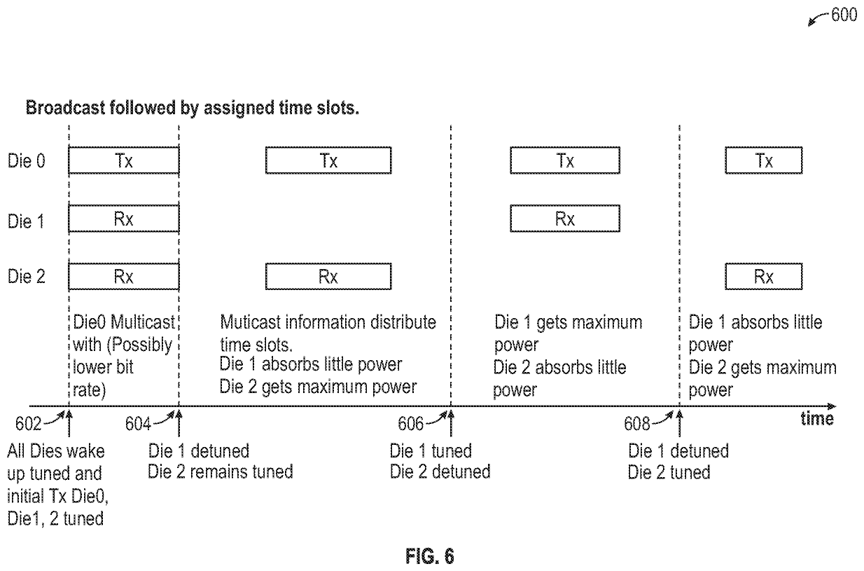

In accordance with another embodiment of the present disclosure, the state information may be determined as a result of a communication protocol. As an example, FIG. 6 depicts a communication protocol 600 in which all dice come out of reset at Time 602 in the tuned state, and the transmit die (die 0) sends a broadcast or multicast message that assigns time slots to all receiving dice. If necessary, the broadcast or multicast message may be sent at a lower data rate and/or a higher transmit power to ensure reception since all receiving dice will have a tuned state. Beginning at Time 604, a sequence of assigned time slots begins, in which receiving die 1 and receiving die 2 exchange receive resonant circuit states: At Time 604, a first assigned time slot begins, in which receiving die 1 is in the detuned state, while receiving die 2 is in the tuned state. At Time 606, a second assigned time slot begins, in which receiving die 2 is in the detuned state, while receiving die 1 is in the tuned state. At Time 608, a third assigned time slot begins, in which receiving die 1 is in the detuned state again, while receiving die 2 is in the tuned state again, etc. The duration of the time slots may be pre-defined and fixed or, after the first time slot, may vary as stated in the broadcast or multicast message. When an upcoming message is generated at die 0, it is transmitted to the target die during an assigned time slot of that die. During that time slot, all other dice will be detuned.

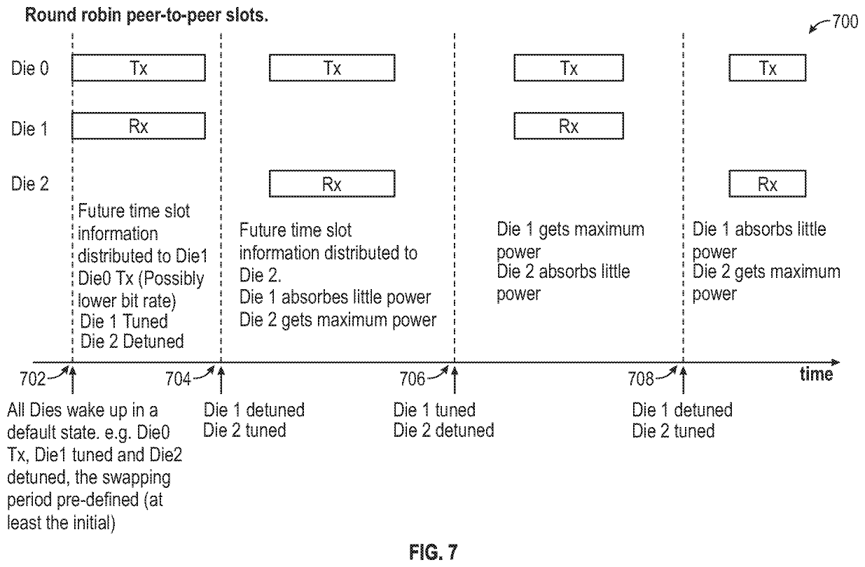

As another example, in accordance with an embodiment of the present disclosure, FIG. 7 depicts a communication protocol 700 in which broadcast and multicast transmission is avoided. Instead, all dice come out of reset (Time 702) in a default state, e.g., die 0 being the transmitter, receiving die 1 being in the tuned state, and receiving die 2 being in the detuned state. Transmit die 0 then transmits future time slot information (e.g., duration, resonant circuit tuned or detuned state, etc.) relevant to receiving die 1 at Time 702 as a unicast message. At this time receiving die 1 is in the tuned state while receiving die 2 is in the detuned state. Transmit die 0 next transmits future time slot information relevant to receiving die 2 at Time 704, also as a unicast message, since receiving die 2 now is in the tuned state while receiving die 1 is in the detuned state. In round-robin, time-division fashion, each receiving die in the inductive communication bus receives future time slot information relevant to it via a unicast message, until all dice have received their information. At this point (e.g., Time 706 in FIG. 7), bus message traffic may begin. At Time 706, a first assigned time slot begins, in which receiving die 1 is in the tuned state, while receiving die 2 is in the detuned state. At Time 708, a second assigned time slot begins, in which receiving die 2 is in the tuned state, while receiving die 1 is in the detuned state, etc. The duration of the time slots may be pre-defined and fixed or, after the first time slot, may vary as stated in the unicast future time slot information message. When an upcoming message is generated at die 0, it is transmitted to the target die during an assigned time slot of that die. During that time slot, all other dice will be detuned.

While the disclosure supra describes a packaged 3D-IC, unpackaged 3D-ICs, and 3D-ICs in chip-scale packages (CSPs), including flip-chip CSPs, customized leadframe-based CSPs, flexible substrate-based CSPs, rigid substrate-based CSPs and wafer-level redistribution CSPs, are also contemplated.

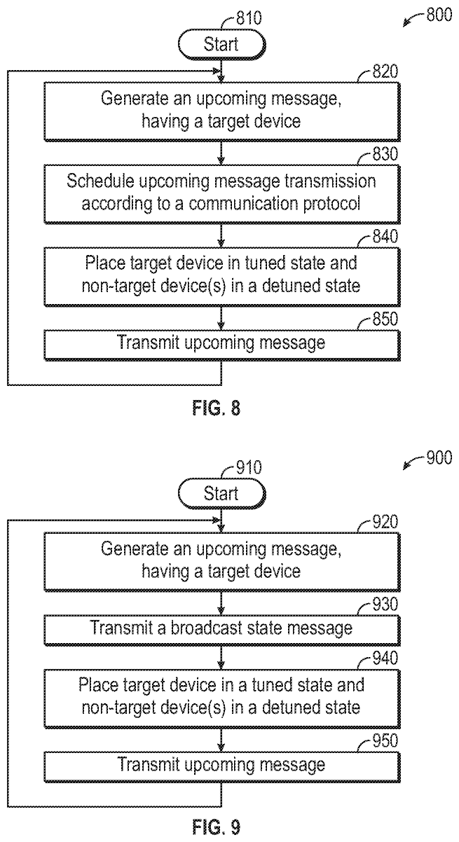

FIGS. 8 and 9 depict flow diagrams representing functionality associated with inductively coupled wireless interconnect of a 3D-IC, in accordance with embodiments of the present disclosure. FIG. 8 depicts flow diagram 800, and FIG. 9 depicts flow diagram 900.

At 810 of flow diagram 800, flow begins.

At 820, an upcoming message is generated, having a target device. An example of the target device that has been described supra is third receive die 335 (die 3).

At 830, transmission of the upcoming message is scheduled, according to a communication protocol. Examples of the communication protocol have been described supra as communication protocol 600 and communication protocol 700.

At 840, the target device is placed in a tuned state and one or more non-target devices are placed in a detuned state. Examples of non-target devices that have been described supra are first receive die 315 (die 1) and second receive die 325 (die 2).

At 850, the upcoming message is transmitted, and flow returns to 820.

At 910 of flow diagram 900, flow begins.

At 920, an upcoming message is generated, having a target device. An example of the target device that has been described supra is third receive die 335 (die 3).

At 930, a broadcast state message is transmitted.

At 940, the target device is placed in a tuned state and one or more non-target devices are placed in a detuned state. Examples of non-target devices that have been described supra are first receive die 315 (die 1) and second receive die 325 (die 2).

At 950, the upcoming message is transmitted, and flow returns to 920.

Embodiments of the present disclosure advantageously provide a method and apparatus for communication. The embodiments described above and summarized below are combinable.

In one embodiment, a method for communication includes a transmitter, configurable to transmit an upcoming message to a target receiver and coupled to a transmit resonant circuit having a transmit frequency of resonance; a first resonant circuit having a first frequency of resonance, a tuned state, in which the first frequency of resonance is the transmit frequency of resonance, and a detuned state, in which the first frequency of resonance is separated from the transmit frequency of resonance by a first frequency offset; a first receiver, coupled to the first resonant circuit and configurable to place the first resonant circuit into the detuned state in response to at least one of a communication protocol and a received message indicating that the first receiver is not the target of an upcoming message, and to place the first resonant circuit into the tuned state when the first receiver is the target of the upcoming message; a second resonant circuit having a second frequency of resonance, a tuned state, in which the second frequency of resonance is the transmit frequency of resonance, and a detuned state, in which the second frequency of resonance is separated from the transmit frequency of resonance by a second frequency offset; a second receiver, coupled to the second resonant circuit and configurable to place the second resonant circuit into the detuned state in response to at least one of a communication protocol and a received message indicating that the second receiver is not the target of the upcoming message, and to place the second resonant circuit into the tuned state when the second receiver is the target of the upcoming message; the upcoming message targeted to at least one of the first receiver and the second receiver, and the transmit resonant circuit, the first resonant circuit, and the second resonant circuit inductively coupled.

In another embodiment of the method, the communication protocol is at least one of round-robin, time-division, and time-slotted protocols.

In another embodiment of the method, at least one of the transmit resonant circuit, the first resonant circuit, and the second resonant circuit comprises an inductive element and a capacitive element.

In another embodiment of the method, the capacitive element comprises one or more of a fixed capacitor, a varactor, and switchable capacitive elements.

In another embodiment of the method, at least one of the first frequency offset and the second frequency offset is a fixed value.

In another embodiment of the method, at least one of the first frequency offset and the second frequency offset is determined, at least in part, by an estimate of communication channel quality.

In another embodiment of the method, the estimate of communication channel quality is based on one or more of a bit error rate measurement, a symbol error rate measurement, a word error rate measurement, and a message error rate measurement.

In another embodiment of the method, the transmit resonant circuit is at a first semiconductor die and at least one of the first resonant circuit and the second resonant circuit is at a second semiconductor die.

In another embodiment of the method, one or more of the transmitter, first receiver and second receiver comprise a transceiver.

In another embodiment of the method, the transmitter is configurable to transmit phase-shift keying modulation.

In another embodiment of the method, the transmitter is configurable to transmit binary phase-shift keying modulation.

In another embodiment of the method, a method for communication includes: inductively coupling a transmit resonant circuit having a transmit frequency of resonance and coupled to a transmitter, a first resonant circuit having a first frequency of resonance and coupled to a first receiver, and a second resonant circuit having a second frequency of resonance and coupled to a second receiver; detuning at least one of the first resonant circuit and the second resonant circuit coupled to at least one of the first receiver and the second receiver from the transmit frequency in response to at least one of a communication protocol and a received message, the detuning indicating that the at least one of the first receiver and the second receiver is not the target of an upcoming message; tuning at least one of the first resonant circuit and the second resonant circuit to the transmit frequency in response to at least one of a communication protocol and a received message, the tuning indicating that the at least one of the first receive and the second receiver is the target of the upcoming message; and transmitting, by the transmitter, the upcoming message to the targeted receiver.

In another embodiment of the method, the communication protocol is at least one of round-robin, time-division, and time-slotted protocols.

In another embodiment of the method, at least one of the transmit resonant circuit, the first resonant circuit, and the second resonant circuit comprises an inductive element and a capacitive element.

In another embodiment of the method, the capacitive element comprises one or more of a fixed capacitor, a varactor, and switchable capacitive elements.

In another embodiment of the method, at least one of the first frequency offset and the second frequency offset is a fixed value.

In another embodiment of the method, at least one of the first frequency offset and the second frequency offset is determined, at least in part, by an estimate of communication channel quality.

In another embodiment of the method, the estimate of communication channel quality is based on one or more of a bit error rate measurement, a symbol error rate measurement, a word error rate measurement, and a message error rate measurement.

In another embodiment of the method, the transmitting is transmitting phase-shift keying modulation.

In another embodiment of the method, the phase-shift keying modulation is binary phase-shift keying modulation.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. An apparatus for communication comprising:
a transmitter, configurable to transmit an upcoming message to a target receiver and operatively coupled to a transmit resonant circuit having a transmit frequency of resonance;
a first resonant circuit having:
a first frequency of resonance,
a tuned state, in which the first frequency of resonance is the transmit frequency of resonance, and
a detuned state, in which the first frequency of resonance is separated from the transmit frequency of resonance by a first frequency offset;
a first receiver, operatively coupled to the first resonant circuit and configurable to place the first resonant circuit into the detuned state in response to at least one of a communication protocol and a received message indicating that the first receiver is not the target of an upcoming message, and to place the first resonant circuit into the tuned state when the first receiver is the target of the upcoming message;
a second resonant circuit having:
a second frequency of resonance,
a tuned state, in which the second frequency of resonance is the transmit frequency of resonance, and
a detuned state, in which the second frequency of resonance is separated from the transmit frequency of resonance by a second frequency offset; and
a second receiver, operatively coupled to the second resonant circuit and configurable to place the second resonant circuit into the detuned state in response to at least one of a communication protocol and a received message indicating that the second receiver is not the target of the upcoming message, and to place the second resonant circuit into the tuned state when the second receiver is the target of the upcoming message,
the upcoming message targeted to at least one of the first receiver and the second receiver, and the transmit resonant circuit, the first resonant circuit, and the second resonant circuit inductively coupled.

2. The apparatus for communication of claim 1, where the communication protocol is at least one of round-robin, time-division, and time-slotted protocols.

3. The apparatus for communication of claim 1, where at least one of the transmit resonant circuit, the first resonant circuit, and the second resonant circuit comprises an inductive element and a capacitive element.

4. The apparatus for communication of claim 3, where the capacitive element comprises one or more of a fixed capacitor, a varactor, and switchable capacitive elements.

5. The apparatus for communication of claim 1, where at least one of the first frequency offset and the second frequency offset is a fixed value.

6. The apparatus for communication of claim 1, where at least one of the first frequency offset and the second frequency offset is determined, at least in part, by an estimate of communication channel quality.

7. The apparatus for communication of claim 6, where the estimate of communication channel quality is based on one or more of a bit error rate measurement, a symbol error rate measurement, a word error rate measurement, and a message error rate measurement.

8. The apparatus for communication of claim 1, where the transmit resonant circuit is at a first semiconductor die and at least one of the first resonant circuit and the second resonant circuit is at a second semiconductor die.

9. The apparatus for communication of claim 1, one or more of the transmitter, first receiver, and second receiver further comprising a transceiver.

10. The apparatus for communication of claim 1, where the transmitter is configurable to transmit phase-shift keying modulation.

11. The apparatus for communication of claim 10, where the transmitter is configurable to transmit binary phase-shift keying modulation.

12. A method for communication comprising:
inductively coupling a transmit resonant circuit having a transmit frequency of resonance and operatively coupled to a transmitter, a first resonant circuit having a first frequency of resonance and operatively coupled to a first receiver, and a second resonant circuit having a second frequency of resonance and operatively coupled to a second receiver;
detuning at least one of the first resonant circuit and the second resonant circuit coupled to at least one of the first receiver and the second receiver from the transmit frequency in response to at least one of a communication protocol and a received message, said detuning indicative that the at least one of the first receiver and the second receiver is not the target of an upcoming message;
tuning at least one of the first resonant circuit and the second resonant circuit to the transmit frequency in response to at least one of a communication protocol and a received message, said tuning indicative that the at least one of the first receive and the second receiver is the target of the upcoming message; and
transmitting, by the transmitter, the upcoming message to the targeted receiver.

13. The method for communication of claim 12, where the communication protocol is at least one of round-robin, time-division, and time-slotted protocols.

14. The method for communication of claim 12, where at least one of the transmit resonant circuit, the first resonant circuit, and the second resonant circuit comprises an inductive element and a capacitive element.

15. The method for communication of claim 14, where the capacitive element comprises one or more of a fixed capacitor, a varactor, and switchable capacitive elements.

16. The method for communication of claim 12, where at least one of the first frequency offset and the second frequency offset is a fixed value.

17. The method for communication of claim 12, where at least one of the first frequency offset and the second frequency offset is determined, at least in part, by an estimate of communication channel quality.

18. The method for communication of claim 17, where the estimate of communication channel quality is based on one or more of a bit error rate measurement, a symbol error rate measurement, a word error rate measurement, and a message error rate measurement.

19. The method for communication of claim 12, where the transmitting is transmitting phase-shift keying modulation.

20. The method for communication of claim 19, where the phase-shift keying modulation is binary phase-shift keying modulation.
